(19) United States
(12) Patent Application Publication
(10) Pub. No.: US 2010/0066100 A1
(43) Pub. Date: Mar. 18, 2010

(54) FASTENING DEVICE FOR A FITTING, E.G. A LOCK CASE, BAR GUIDE, OR SIMILAR

(76) Inventor: Dieter Ramsauer, Schwelm (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 12/444,253

(22) PCT Filed: Aug. 22, 2007
(86) PCT No.: PCT/EP07/07496

§ 371 Date: Apr. 3, 2009

(30) Foreign Application Priority Data
Oct. 6, 2006 (DE) 20 2006 015 306.3

(51) Int. Cl. E05C 9/00; E05C 9/10

(52) U.S. Cl. 292/8; 292/42

(57) ABSTRACT

The description is of a fastening device for securing a fitting such as a lock case, bar guide, or the like, to the back of a thin wall such as a sheet metal cabinet door which is provided, if necessary, with an opening for the fitting. According to the invention, a projection such as a nose, shoulder, head pin or bent portion projects from the back, possibly from the edge area of the opening, if any, which projection forms at its free end a recess or notch or opening or fold behind which a clip element projecting from the fitting engages in the mounted position so as to secure the fitting to the wall.

The present application claims priority from PCT Patent Application No. PCT/EP2007/007496 filed on Aug. 22, 2007, which claims priority from German Patent Application No. 20 2006 015 306.3 filed on Oct. 6, 2006, the disclosure of which is incorporated herein by reference in its entirety.

### BACKGROUND OF THE INVENTION

1. Field of the Invention

The invention is directed to a fastening device for securing a fitting such as a lock case, bar guide, or the like, to the back of a thin wall such as a sheet metal cabinet door that is provided, if necessary, with an opening for the fitting.

2. Description of Related Art

A fastening device of the type mentioned above is already known from WO 20051071193A1.

The fittings in the reference are bar locks, certain areas of which are inserted from the outside through openings arranged in a thin wall, another lock case part then being fitted to this inserted area from the rear and locked, the door leaf or the thin wall being clamped between the two parts of the lock case. The trend in the automobile industry and in switch cabinet manufacturing is to accelerate and simplify the production process by automated assembly. It is advantageous for assembly robots when the various parts of a lock can be mounted in the thin wall from the same side, preferably from the rear. This has not yet been fully realized in the prior art because one part must initially be inserted through an opening in a thin wall from the front so that another part of the lock can be fitted from the rear to complete the assembly process.

### SUMMARY OF THE INVENTION

It is the object of the invention to provide a fastening device for securing a fitting such as a lock case, bar guide, or the like, which can be mounted entirely on the back of a thin wall such as a sheet metal cabinet door which is provided, if necessary, with an opening for the fitting so that the use of assembly robots can be realized in a particularly simple manner.

The above-stated object is met in that a projection such as a nose, shoulder, head pin or bent portion projects from the back, possibly from the edge area of the opening, if any, which projection forms at its free end a recess or notch or opening behind which a clip element projecting from the fitting engages in the mounted position so as to secure the fitting to the wall.

An object of this type is suitable for mounting in a simple manner by an industrial robot, which can appreciably reduce the cost of producing, e.g., switch cabinets with lock devices.

According to a further development of the invention, the projection is a metal hook which is bent in an S-shape, one of whose ends is spot-welded to the thin wall and whose other end forms a grip surface for a clip-type holding element.

According to another alternative, the projection is a metal strip which is bent in a U-shape and whose free U-leg ends are spot-welded to the thin wall, the connecting web between the U-legs forming the grip surface for a clip-type holding element.

According to another embodiment form, the projection is a welding pin or metal profile piece which is welded by its base to the back of the thin wall and is characterized in that the head of the welding pin or a projection of the metal profile piece forms the grip surface for a clip-type holding element.

According to another embodiment form, the projection is a sheet metal strip which projects from the edge of the opening and which has an aperture with an aperture edge that is remote of the wall parallel thereto to form a grip surface for clip-type holding means, and the sheet metal strip is either welded or spot-welded to the wall or formed by bending sheet metal material out of the wall when producing the opening.

The projection can be formed by a fold of the edge of a sheet metal door leaf or the like, wherein a notch in the fold profile forms a grip surface for clip-type holding means, the fold forming a U-profile which opens toward the center of the door or a closed rectangular profile.

The holding element can be a slide which slides in a rectangular channel against spring force and whose outwardly directed front end forms a first inclined surface serving as an entry surface and a second inclined surface which is substantially perpendicular to the first inclined surface and serves for locking without play.

Alternatively, the holding element can be a leaf spring which is bent in a V-shape and which is anchored in the front end of the fitting part by the free end of one of the two V-legs, while the other V-leg forms a first inclined surface serving as an entry surface and a second inclined surface which is substantially perpendicular to the first inclined surface and which serves for locking without play.

The spring can project from the end face of the fitting part so as to be integral therewith and be made of plastic.

The plastic spring can be reinforced by a flexible metal covering.

A fastening device according to one of the embodiments mentioned above can be provided for a box-shaped fitting part such as a lock case which is characterized in that it forms a base which can be inserted into the opening in the thin wall.

An annular groove for receiving an 0-ring seal can be provided in the annular supporting surface of the shoulder.

It is advantageous when a flange can be fitted to the base part projecting through the opening because this is more appealing visually and also mitigates the penetration of dust.

The box or case may comprise two parts as in the prior art, and the two parts can be locked together by the clip devices.

### BRIEF DESCRIPTION OF THE DRAWINGS

FIGS. 1A to 1E show different views of a fastening device according to the invention, in the present instance in the form of a lock case for a key-operated bar lock;

FIGS. 2A to 2E show views similar to those in FIGS. 1A to 1E of another key-operated bar lock according to the invention;

FIGS. 3A to 3E show views similar to those above of another type of lock case constructed according to the invention for a bar lock;

FIGS. 4A to 4E show views similar to those above of another embodiment form for a lock case of a bar lock, wherein the lock case is formed of two parts; and

FIGS. 5A to 5E show different views of a bar lock with a bar guide which can be mounted through sheet metal fold arrangements according to the invention, wherein FIG. 5D shows the holding area of a door fold for a lock case according to FIGS. 5A to 5E.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

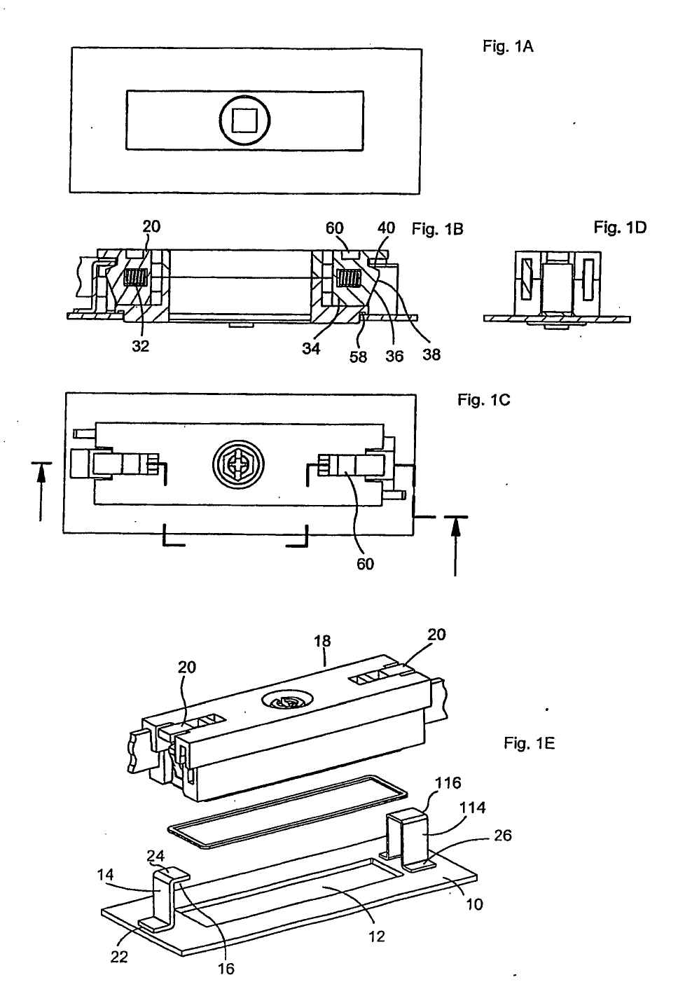

A fitting in the form of a lock case of a lock case for a bar lock is shown in a top view in FIG. 1A, a sectional view in FIG. 1B according to the section line in FIG. 1C, a rear view in FIG. 1C, a front view in FIG. 1D, and an exploded, perspective view in FIG. 1E. The fitting is outfitted with a fastening device according to the invention which makes it possible to mount the fitting from the rear on a thin wall provided with an opening, specifically also by means of an industrial robot.

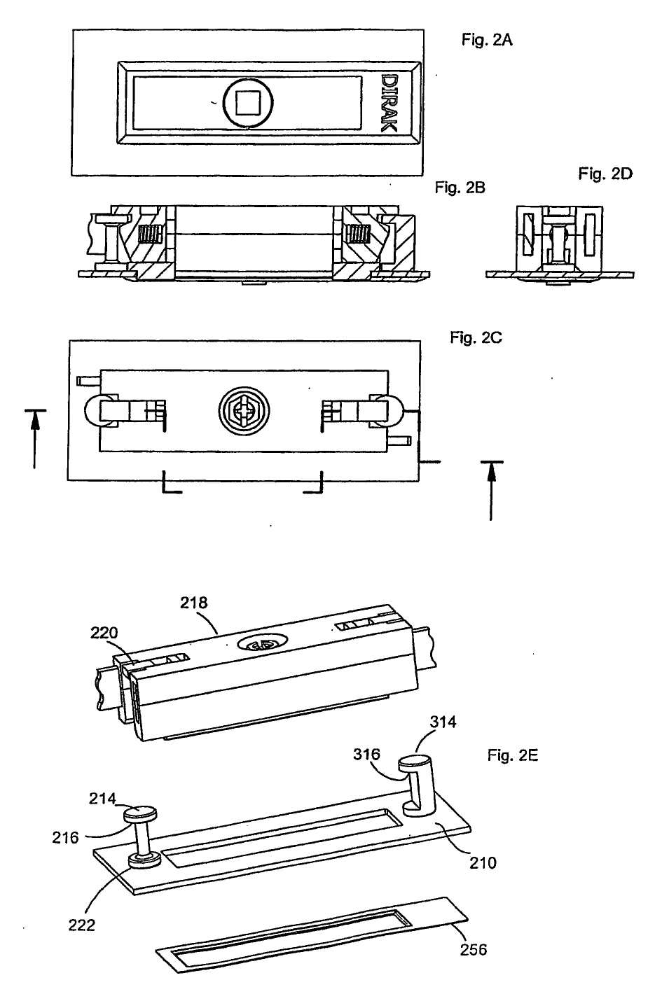

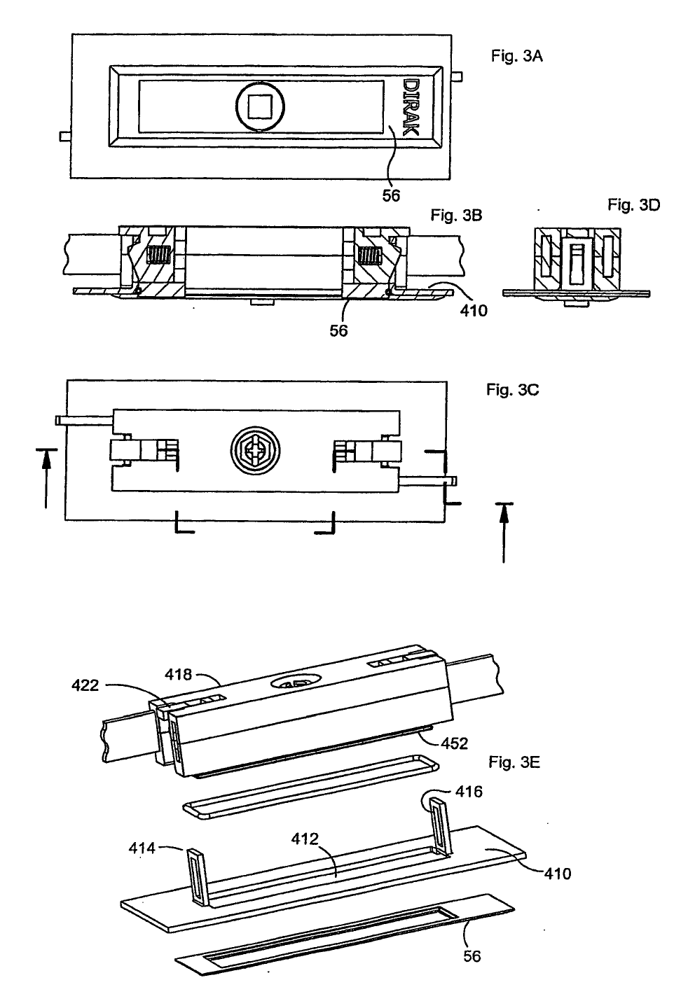

As is shown particularly in the exploded view in FIG. 1E, a thin wall 10 is provided with an opening 12 having, in this case, a rectangular shape. A projection 14 such as a nose, shoulder, head pin or bent portion projects from the back of the thin wall 10 in the edge area of the opening 12. The projection forms at its free end a recess 16 or 316 according to FIG. 2E, or opening (see reference number 416 in FIG. 3E), and a bent portion or fold (see reference numbers 16 and 116 in FIG. 1E). A clip element 20, 520 projecting from the fitting 18, 218, 418, 518, 618, 718 engages behind this recess, notch, opening or bent portion in the mounted position so as to secure the fitting to the wall 10. As shown on the left-hand side in FIG. 1E, the projection is a metal hook 14 which is bent in an S-shape, one of whose ends is spot-welded (see reference number 22) to the thin wall 10, its other end 24 forming a grip surface 16 for a clip-type holding element 20. In contrast, the right-hand side of FIG. 1E shows a projection in the form of a metal strip 114 which is bent in a U-shape and whose free U-leg ends are spot-welded to the thin wall 10, the web between the U-legs forming the grip surface 116 for a clip-type holding element 20.

In FIG. 2E, the projection 214 shown on the left-hand side is a welding pin and, on the right-hand side, a metal profile piece 314. The welding pin is spot-welded 222 by its base to the back of the thin wall 210, while the head of this welding pin 214 forms the grip surface 216 for a clip-type holding element 220. On the right-hand side in FIG. 2E, a round profile 314 provided with a notch is provided instead of the welding pin and forms the grip surface 316.

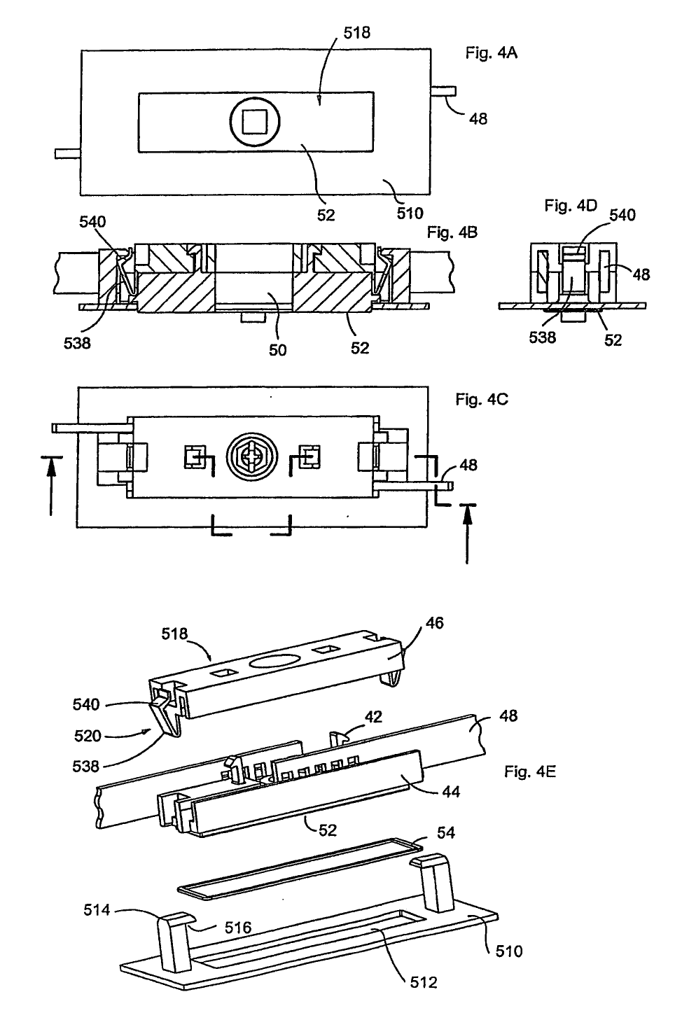

The projection 514 shown in FIG. 4E is a rectangular profile with a head which forms a grip surface 516.

A spring-shaped projection 520 engages in this grip surface 516.

According to FIG. 3E, the projection 414 is a sheet metal strip 414 which projects from the edge of the opening 412 in the thin wall 410 at the front and is either welded or spot-welded on the wall 410 or could be formed by bending the sheet metal material out of the wall 410 when producing the opening 412. The sheet metal strip forms an aperture with an aperture edge 416 remote of the wall 410 and parallel thereto for forming the grip surface for clip-type holding means 422.

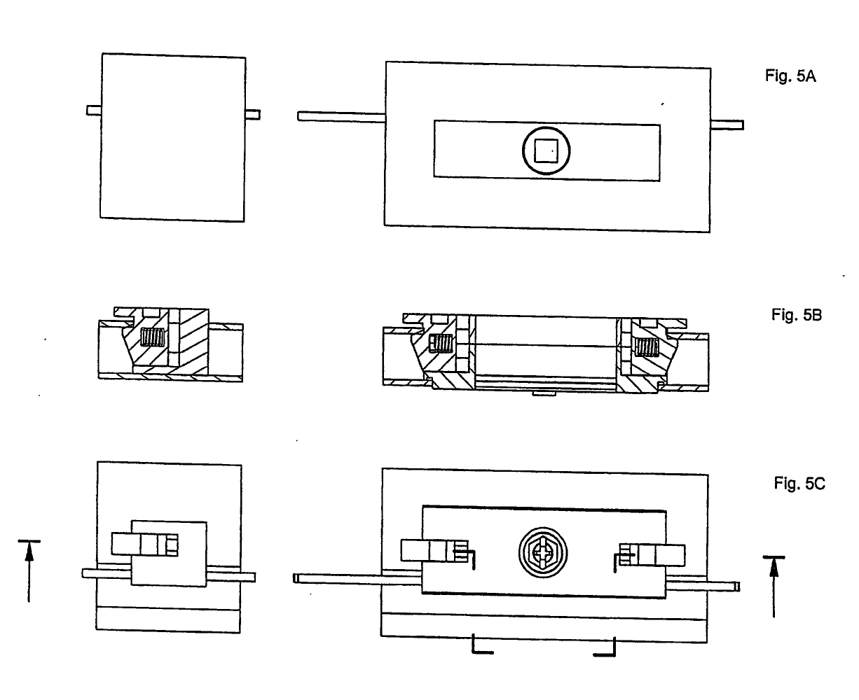

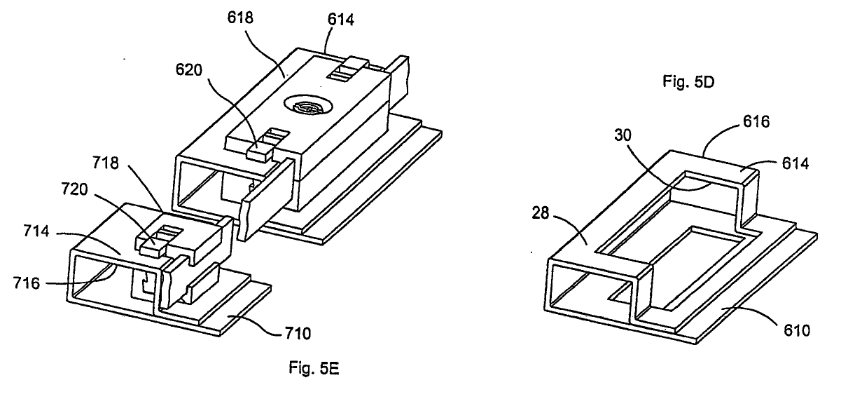

According to embodiment forms in FIGS. 5D and 5E, the projection 614 and 714, respectively, is formed by a fold 28 of a sheet metal door leaf 610 and 710, respectively. A notch 30 in the fold profile 28 forms a grip surface 616 for clip-type holding means 622 and 722, respectively. The fold 28 forms a U-profile which opens toward the center of the door or a closed rectangular profile (as is shown in FIGS. 5E and 5D). The holding element 20 can be a slide 34 which slides in a rectangular channel against spring force (see spring 32 in FIG. 1B) and whose outwardly directed front end 36 forms a first inclined surface 38 serving as an entry surface 38 and a second inclined surface 40 which is substantially perpendicular to the first inclined surface 38 and which serves to lock at the rear wall surface without play.

This slide-like holding element shape is also found in the embodiment forms according to FIGS. 2A to 2E, 3A to 3E, and 5A to 5E, while the holding element 520 in the embodiment form according to FIGS. 4A to 4E is a leaf spring which is bent in a V-shape and anchored in the front end of the fitting part, a two-part lock case according to FIGS. 4A to 4E, by the free end of one of the two V-legs, while the other V-leg forms a first inclined surface 538 serving as an entry surface and a second inclined surface 540 (see FIG. 4B) which is substantially perpendicular to the first inclined surface and serves for play-free locking.

The spring 524 can project from the end face of the fitting part integral therewith, these two parts being made of plastic. However, the plastic spring can also be reinforced by a flexible metal covering or replaced by a metal spring mounted in the plastic.

Reference is had to the prior art for details concerning the shape of the holding elements and the construction of two-part, clip-in lock case arrangements. According to FIGS. 4A to 4E, clip hooks 42 hold together the two halves 44 and 46 of the lock case when they have been mounted. The lock case 518 shown in this instance, as well as other lock cases shown herein, support locking bars 48 and a pinion 50, not shown in more detail, which meshes with perforations in the locking bar 48 and displaces the locking bar 48 when rotated.

The box-shaped fitting, that is, for example, the lock case 518, preferably has fastening devices according to one of the preceding embodiment forms. In particular, it forms a base 52 which can be inserted snugly into the opening 512 in the thin wall 510. The base prevents a displacement of the lock case in direction of the plane of the thin wall 510, while the projections 516 and the support at the thin wall 510 prevent displacement perpendicular to the plane.

The shoulder of the base 52 forms an annular supporting surface in which an annular groove 58 can be provided for receiving an O-ring seal 54.

In the embodiment form according to FIGS. 3A to 3E, a flange 56 can be fitted to the base part 452 projecting through the opening 412.

FIG. 5E shows that fitting parts which do not require an opening through which a key or the like can be inserted can be mounted without an opening according to the invention. This is shown, for example, by the bar guide 718 at lower left in FIG. 5E.

The locking parallel to the wall 710 is carried out by means of the notch in the fold part 716.

The advantage of the fittings described above consists in that, in principle, they can be mounted from the rear by means of assembling machines and robots without human assistance. Mounting is also possible in that the slide-shaped holding elements 34 can be drawn back, for example, by engaging in recesses 60 of these holding elements 34, and accordingly come out of the grip surface.

### COMMERCIAL APPLICABILITY

The invention is commercially applicable in switch cabinet construction.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### REFERENCE NUMBERS

10, 210 thin wall
12 rectangular opening
14, 114, 214, 314, 414, 514, 614, 714 projection
16, 116, 216, 316, 416, 516, 616, 716 recess, notch, bent portion, fold
18, 218, 418, 518, 618, 718 fitting
20, 520 clip element
22, 222 end, spot-weld
24 end
26 free end of the U-leg
28 fold
30 notch
32 spring
34 slide
36 front end
38, 538 first inclined surface, entry surface
40, 540 second inclined surface for play-free locking
42 clip hook
44 bottom half of lock case
46 top half of lock case
48 locking bars
50 pinion
52 base
54 O-ring seal
56 flange
58 annular groove
60 recess

1. A fastening device for securing a fitting such as a lock case, bar guide, or the like, to the back of a thin wall such as a sheet metal cabinet door which is provided, if necessary, with an opening for the fitting,
wherein a projection such as a nose, shoulder, head pin or bent portion projects from the back, possibly from the edge area of the opening, if any, the projection forming at its free end a recess or notch, or opening or fold, behind which a clip element projecting from the fitting engages in the mounted position so as to secure the fitting to the wall.

2. The fastening device according to claim 1 1;
wherein the projection is a metal hook which is bent in an S-shape, one of whose ends is spot-welded to the thin wall, its other end forming a grip surface for a clip-type holding element.

3. The fastening device according to claim 1;
wherein the projection is a metal strip which is bent in a U-shape and whose free U-leg ends are spot-welded to the thin wall, wherein the connecting web between the U-legs forms the grip surface for a clip-type holding element.

4. The fastening device according to claim 1;
wherein the projection is a welding pin or metal profile piece which is welded by its base to the back of the thin wall, and in that the head of the welding pin or a projection of the metal profile piece forms the grip surface for a clip-type holding element.

5. The fastening device according to claim 1;
wherein the projection is a sheet metal strip which projects from the edge of the opening and which has an aperture with an aperture edge that is remote of the wall parallel thereto to form a grip surface for clip-type holding means, and the sheet metal strip is either welded or spot-welded to the wall or formed by bending sheet metal material out of the wall when producing the opening.

6. The fastening device according to claim 1;
wherein the projection is formed by a fold of the edge of a sheet metal door leaf or the like, wherein a notch in the fold profile forms a grip surface for clip-type holding means, wherein the fold forms a U-profile which opens toward the center of the door or a closed rectangular profile.

7. The fastening device according to claim 1;
wherein the holding element is a slide which slides against spring force in a channel comprising multiple parts and whose outwardly directed front end forms a first inclined surface serving as an entry surface and a second inclined surface which is substantially perpendicular to the first inclined surface and which serves for locking without play.

8. The fastening device according to claim 1;
wherein the holding element is a leaf spring which is bent in a V-shape and which is anchored in the front end of the fitting part by the free end of one of the two V-legs, while the other V-leg forms a first inclined surface serving as an entry surface and a second inclined surface which is substantially perpendicular to the first inclined surface and which serves for locking without play.

9. The fastening device according to claim 8;
wherein the spring projects from the end face of the fitting part integral therewith and is made of plastic.

10. The fastening device according to claim 9;
wherein the plastic spring is reinforced by a flexible metal covering.

11. A box-shaped fitting part such as a lock case with a fastening device according to claim 1;
wherein the fastening device forms a base which can be inserted into the opening in the thin wall.

12. The box-shaped fitting part according to claim 11;
wherein an annular groove for receiving an O-ring seal is provided in the annular supporting surface of the shoulder of the base.

13. The box-shaped fitting part according to claim 11;
wherein a flange can be fitted to the base part projecting through the opening.

14. The box-shaped fitting part according to claim 11;
wherein the box is formed of two parts, and the two parts can be locked together by clip devices.

15. The box-shaped fitting part according to claim 11;
wherein the box-shaped fitting part is a lock case in which locking bars are driven by a pinion.

16. The box-shaped fitting part according to claim 11;
wherein the fitting part is a bar guide.
